(19) United States
(12) Patent Application Publication
(10) Pub. No.: US 2024/0321270 A1
(43) Pub. Date: Sep. 26, 2024

(54) VIRTUAL ASSISTANT NOTIFICATION AMELIORATION AND AWARENESS SYSTEMS AND METHODS

(71) Applicant: International Business Machines Corporation, Armonk, NY (US)

(72) Inventors: Zachary A. Silverstein, Georgetown, TX (US); Jacob Ryan Jepperson, St. Paul, MN (US); Spencer Thomas Reynolds, Austin, TX (US); Jeremy R. Fox, Georgetown, TX (US)

(21) Appl. No.: 18/189,603

(22) Filed: Mar. 24, 2023

(51) Int. Cl. G10L 15/22; G06F 16/68; G10L 15/18

(52) U.S. Cl. CPC G10L 15/22; G06F 16/686; G10L 15/1822; G10L 2015/088; G10L 2015/228

(57) ABSTRACT

A computer-implemented method, a computer program product, and an apparatus for performing virtual assistant notification amelioration and awareness. A computer-implemented method includes receiving situational information for a device executing a virtual assistant application program and initiating a previously generated virtual assistant activation rule responsive to the situational information matching situational information associated with the previously generated virtual assistant activation rule. The previously generated virtual assistant activation rule includes altering an output produced by the device executing the virtual assistant application program. Altering includes deactivating an output produced by the device executing the virtual assistant application program during normal operating conditions and delaying the output produced by the device executing the virtual assistant application program or changing the output produced by the device executing the virtual assistant application program to another output format.

### BACKGROUND

The subject matter disclosed herein relates to virtual assistants and more particularly relates to operational control of virtual assistants.

Virtual assistants operate autonomously on user devices. They typically respond to spoken words by a user of the device.

### SUMMARY

An apparatus for virtual assistant notification amelioration and awareness is disclosed. A computer-implemented method and computer program product also perform the functions of the apparatus. According to an embodiment of the present invention, a computer-implemented method includes receiving situational information for a device executing a virtual assistant application program and initiating a previously generated virtual assistant activation rule responsive to the situational information matching situational information associated with the previously generated virtual assistant activation rule.

A computer program product includes a computer readable storage medium having program instructions embodied therewith. The program instructions executable by a device to cause the device to receive situational information for a device executing a virtual assistant application program and initiate a previously generated virtual assistant activation rule responsive to the situational information matching situational information associated with the previously generated virtual assistant activation rule.

An apparatus includes a memory a computer readable storage medium having program instructions embodied therewith, an output device configured to output notifications, an input device configured to sense or receive input, a location sensing device configured to determine location of the apparatus, a communication device configured to receive or transmit signals external to the apparatus, and a processor configured to execute the program instructions. The program instructions cause the processor to receive situational information for a device executing a virtual assistant application program, initiate a previously generated virtual assistant activation rule responsive to the situational information matching situational information associated with the previously generated virtual assistant activation rule, output a virtual assistant notification via the output device, sense a user action after outputting the virtual assistant notification via the input device, and create a new virtual assistant activation rule responsive to the user action.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system in accordance with one embodiment of the present invention;

FIG. 2 is a schematic block diagram illustrating one embodiment of a system in accordance with one embodiment of the present invention;

FIG. 3 is an image of a scenario where an embodiment of the present invention is implemented;

FIG. 4 is a block diagram illustrating one example of a computing stack in accordance with at least one embodiment disclosed herein.

FIG. 5 is a schematic flow chart diagram illustrating one embodiment of a method for adapting a virtual assistant in accordance with one embodiment of the present invention; and

FIG. 6 is a schematic flow chart diagram illustrating one embodiment of a method for adapting a virtual assistant in accordance with one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof' includes only A, only B, only C, a combination of A and B, a combination of B and C, a combination of A and C or a combination of A, B and C.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be an apparatus, a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of elements in each figure may refer to elements of proceeding figures. Like numbers refer to like elements in all figures, including alternate embodiments of like elements.

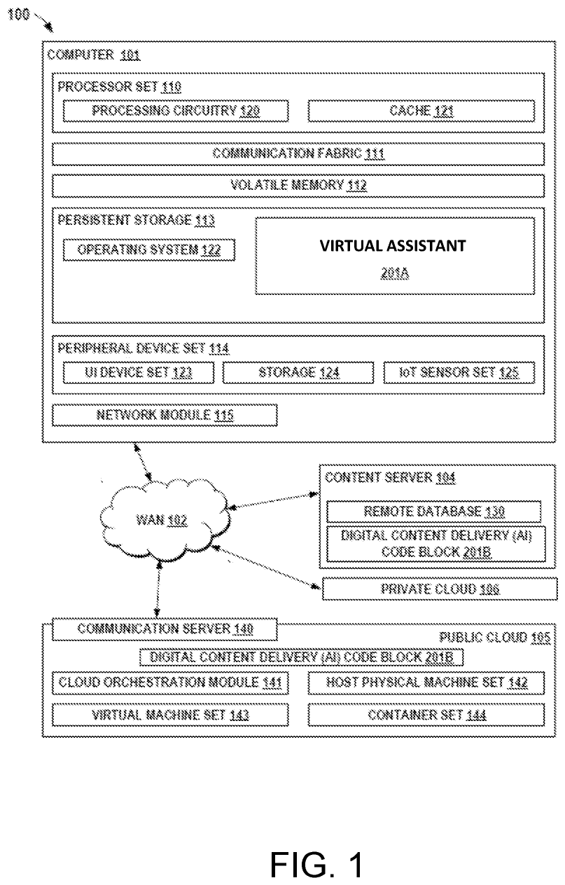

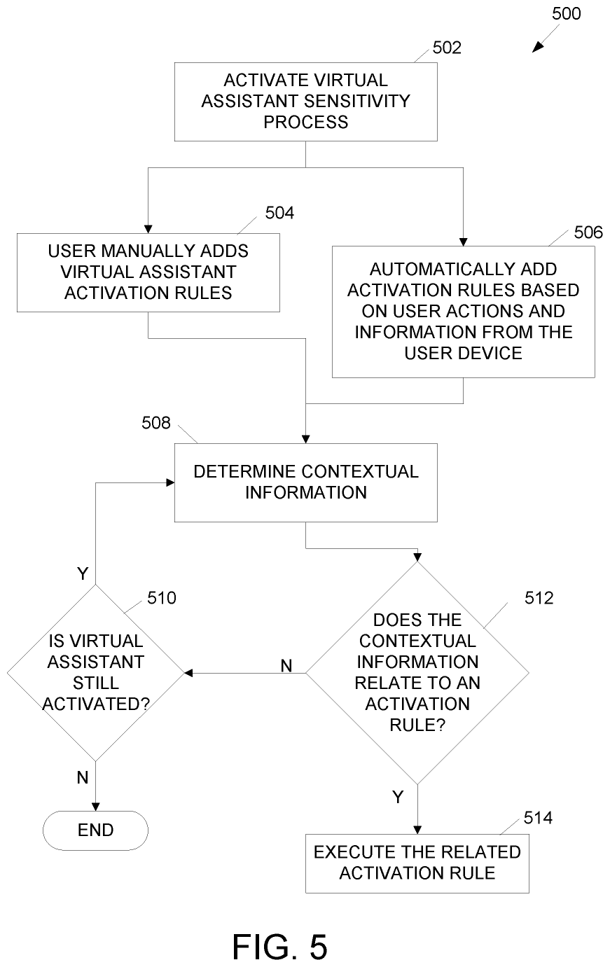

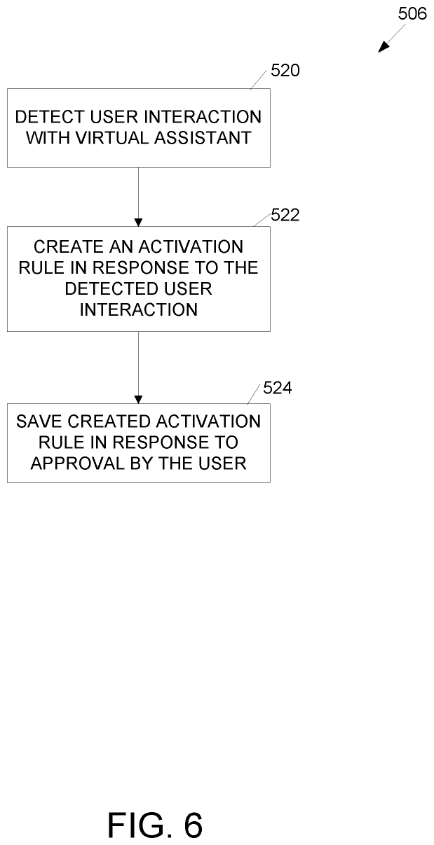

FIG. 1 is a block diagram illustrating various portions of a computing environment 100 in accordance with at least one embodiment disclosed herein. Computing environment 100 contains an example of an environment for the execution of at least some of the computer code involved in performing the inventive methods or processes, such as code block 201 (corresponding to the method 500 shown in FIGS. 5 and 6). In some embodiments, portions of code block 201 reside within the operating system 122. In addition to block 201, computing environment 100 includes, for example, computer 101, wide area network (WAN) 102, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and virtual assistant 201A, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any a U type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented process, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods such as identifying data errors.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

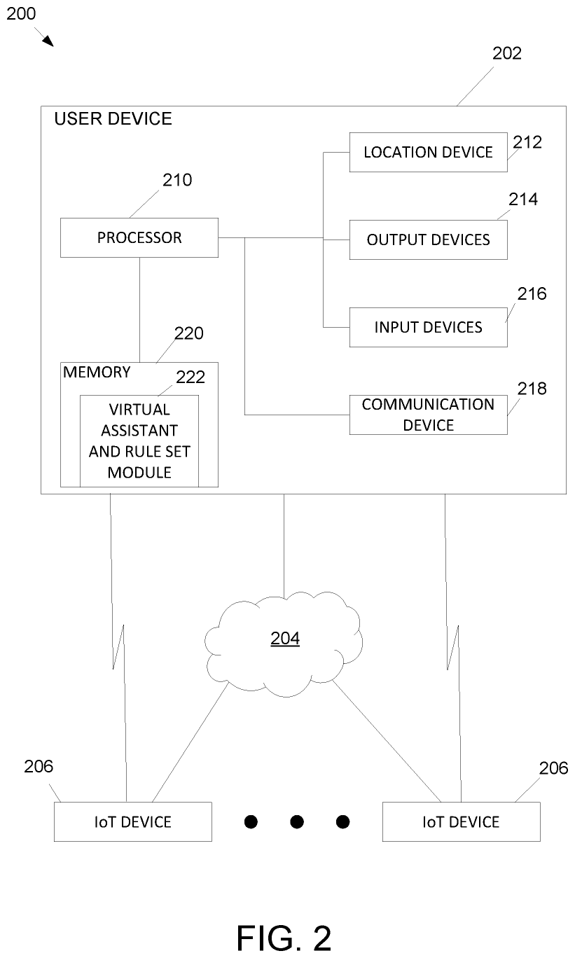

In various embodiments, referring to FIG. 2, a system 200 performs a method to capture current user context based on surroundings, time, and location to control virtual assistant user experience interaction with dynamic activation rules. The system 200 includes a user device 202, a network 204, and one or more Internet of things (IoT) devices 206. The user device 202 includes a processor 210, a location device 212, an output device(s) 214, an input device(s) 216, a communication device 218, and memory 220. The user device 202 may be any type of computing device, such as, without limitation, a smart phone, a personal data assistant (PDA), a cell phone, a smartwatch, a laptop, a computer, a tablet, or the like. The memory 220 includes a virtual assistant and rule set module 222. The virtual assistant and rule set module 222 when executed by the processor 210 causes the processor 210 to receive information from the location device 212, the input device(s) 216, and the communication device 218, perform virtual assistant operations according to the received information and send or not send communication(s) to the output device(s) 214 depending upon the results of the performed virtual assistant operations. The memory 220 may also include other software modules, such as, without limitation, an operating system, or the like.

In various embodiments, the location device 212 may include a global positioning system (GPS) or a device for determining a precise location of the user device 202 based on information received from other proximate devices, such as the IoT devices 206. The precise location of the user device 202 may include a building location, a room within a building, a location within a room in a building, or the like. The output device(s) 214 may include any device that produces a sense to output, such as, without limitation a haptic device, a display device, a speaker, or the like. The input device 216 may include any device that allows a user to interact with the user device 202. The input device 216 may be a motion sensor, a microphone, a touch screen display, a mouse, a cursor control device, or the like. The communication device 218 may include a radio transceiver, or a wired or wireless network communication device for allowing communication with other devices (e.g., IoT devices 206).

In various embodiments, the IoT device 206 may be any device that is capable of communicating with a local or wide area network. The IoT device 206 may also include similar components as those included in the user device 202.

In various embodiments, the user device 202 allows a user to manually enters activation rules for virtual assistant sensitivity reduction when certain situational information exists, such as a particular geolocation, presence of certain IoT device(s) 206 (having a universal unique identifier (UUID)), a particular time, a particular calendar event/type, or other information from proximate IoT device(s) 206. The activation rules are stored in the memory 220, with the module 222, or remotely, such as with a server (not shown) coupled to the network 204.

In various embodiments, the module 222 (i.e., a virtual assistant) activates as per a normal behavioral/operational mode. The user responds shortly after with a cancellation or negative context command. The user response is captured by the input device 216. The user command may be a word, phrase, or other interaction with the user device 202 (e.g., shaking, repeated activation of a physical or on-screen button). An example word/phrase may be “Alexa stop” or “Sorry everyone, I need to turn off my virtual assistant.” Also, the user command may be in the form of rapid, multiple clicks in succession of the input device 216 (e.g., a deactivation button).

The processor 210, as commanded by the module 222, may request the user to confirm that context/situation in which to ignore the virtual assistant activation is temporary or permanent. The processor 210 checks if an activation rule has been found to be actively occurring (i.e., sensed situational information matches situational information associated with the activation rule). If an activation rule is found, the activation rule is modified to not activate under normal conditions and may require extra conditions in order to activate.

If no activation rule is found, the processor 210 continues monitoring and automatically adds a new activation rule to a watched corpus of activation rules. The processor 210 maintains historical knowledge corpus of behaviors in the memory 220 as to why a virtual assistant activation occurred by analyzing the historical knowledge corpus to understand the reasons (what, when, where, why, & how) a virtual assistant activation was cancelled or suppressed.

In various embodiments, the processor 210 can provide a “pop-up” confirmation. The “pop-up” confirmation may not include any audible sound interruption to the user. The processor 210 previously learned and applied a silencing rule. The user may want to evolve the behavior for other unparticular instances of usage.

In various embodiments, if the location associated with an activation rule is the user's home, place of normal business, or other predefined location, rule behavior modification may evolve over time. Through a real-time pop-up interface confirmation on a wearable device (e.g., the user device 202), the user confirms that an activation rule is still active, ignore it, or confirm a rule modification for a particular instance within the activation rule.

In various embodiments, an activation rule causes the virtual assistant to never activate while the user is on the phone during business hours. Within an instance where the user is on the phone during business work hours, the virtual assistant might provide a haptic vibration response to the user instead of an audible response. The user confirms that they are not on an important phone call and want to override the activation rule temporarily within this one instance, but still maintain the normal activation rule behavior for future usage. The user device 202 may then seek to determine patterns for these exceptions and recommend additional/updated rulesets as confidence in the determined pattern exceeds some predefined threshold.

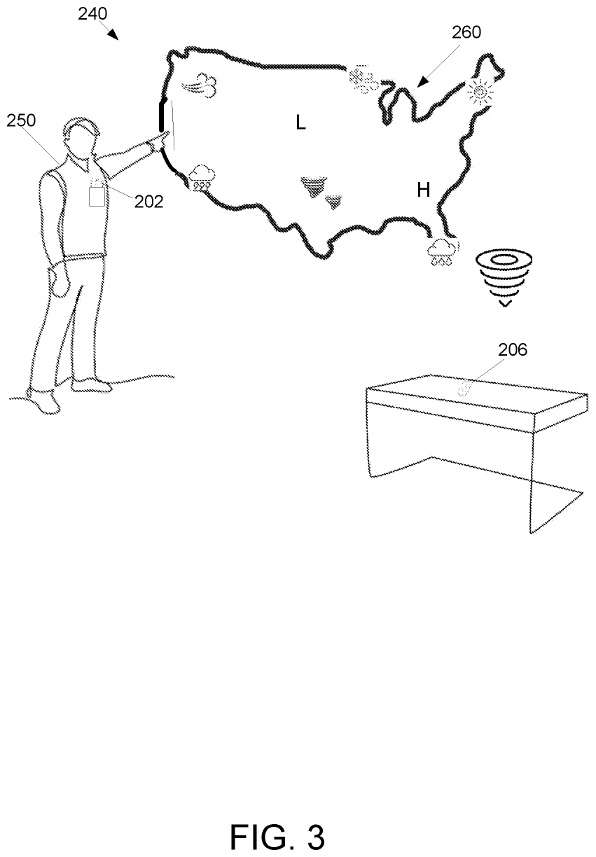

In various embodiments, as shown in FIG. 3, an example scenario illustrates a television weather room 240 that includes a weatherperson 250 carrying the user device 202. The IoT device 206, in this example, is a cell phone that is located on a table somewhere else in the weather room 240. As the weatherperson 250 is describing the weather as shown on a display 260 to cameras located within the weather room 240, the virtual assistant that is located on the user device 202 may inadvertently activate during the weatherperson's presentation, as a result of the weatherperson 250 saying a wake word or something that sounds like the wake word, if no activation rule is associated with this scenario (i.e., situational information). Soon after the virtual assistant's inadvertent response to the weather person 250, the weatherperson 250 instructs, either by a voice command or other interactions with the input device 216, the user device 202 to cease any output produced by the virtual assistant. In response to the actions of the weatherperson 250, the processor 210 of the user device 202 stops output produced by the virtual assistant and then assesses whether and activation rule should be created. The processor 210 considers many factors when determining whether to make a new activation rule. Some of the factors that the processor 210 will consider will be location information received from the IoT device 206 and/or the location device 212 and other situational information. The other situational information may include time of day, day of the week, work hours, information included in a calendar application associated with the user device 202, motion information of the user device 202 or any other information that can be associated with the event that is occurring when the user requested to deactivate the virtual assistant. The processor 210 may also analyze the specific actions and/or words that the weatherperson 250 performed during and/or within a predefined period of time when the virtual assistant delivered the output.

In one example, a user's smartwatch detects anytime the user is around their manager by sensing proximity to the manager's cell phone or smartwatch (i.e., an IoT device). Upon detecting proximity to the manager, a virtual assistant rule may be changed such that the virtual assistant requires a more complex command to activate in order for the virtual assistant to remain silent while in proximity to the manager.

In another example, Jane is a prominent University Professor providing a guest lecture on Quantum Computing to her class every Monday & Wednesday from 10:00 a.m. to 11:20 a.m. She never wants to have her virtual assistant (e.g., smartwatch) bothering her during her presentations. She may manually enter activation rules and/or may allow her device/virtual assistant to automatically create activation rules. There are other IoT devices (e.g. student cell phones) within the lecture hall that may provide situational information the Jane device that a lecture is occurring. Her location can be confirmed by those IoT devices and/or by a location device component located on her smartwatch. One of her students has the same name as the wake word (e.g., Alexa) for the virtual assistant. During Jane's lecture, she calls on the student (Alexa) after Alexa raises her hand. The virtual assistant interrupts Jane in response to hearing the wake word. The virtual assistant says, “I do not understand your question, please rephrase it.” Jane instructs the virtual assistant to not interrupt until after 11:20 a.m. each Wednesday. Jane's device determines to create an activation rule for the virtual assistant based on the response from Jane soon after the virtual assistant requested clarification. The created activation rule includes the time (weekly on Wednesday) and the location (lecture hall) as associated situational information.

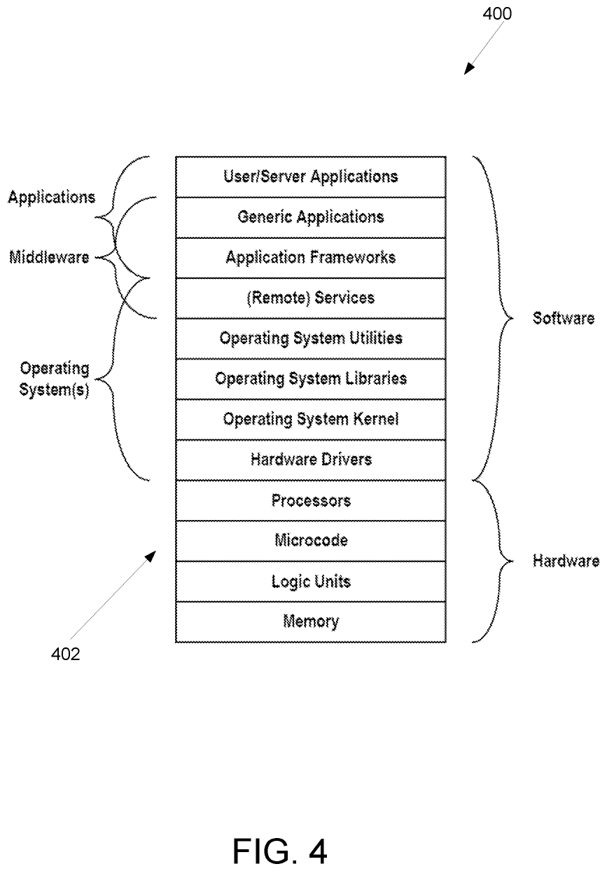

FIG. 4 is a block diagram illustrating one example of a computing stack 400 in accordance with at least one embodiment disclosed herein. As depicted, the computing stack 400 includes a number of computing layers 402 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage, and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, I/O buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 101 and/or the end user devices 103. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

Referring to FIG. 5, a schematic flow chart diagram illustrates one embodiment of a method 500 for altering virtual assistant activation and creating virtual assistant activation rules. At least in the illustrated embodiment, the method 500 includes activating a virtual assistant sensitivity process (block 502). The method 500 then performs either adding virtual assistant activation rules based on user manual input (block 504) or automatically adding activation rules based on user actions and/or situational information from components of the user device. The method 500 then determines contextual information (block 508), which is performed continuously to determine whether the contextual information is related to an associated manually or automatically created activation rule. The method 500 includes determining if the contextual information relates to a previously created activation rule (decision block 512). If the contextual information does relate to an activation rule, then the user device executes the activation rule (block 514). If the contextual information does not relate to activation rule, the method 500 determines if the essay virtual assistant is still activated (decision block 510). If the virtual assistant is still activated then, the method 500 returns to the block 508. If the virtual assistant is not activated then the method 500 ends.

Referring to FIG. 6, the step at the block 506 (FIG. 5) further includes detecting user interaction with the virtual assistant (block 520), creating an activation rule in response to the detected user interaction (block 522), and saving the created activation rule in response to approval by a user (block 524).

In one embodiment, a computer-implemented method comprises receiving situational information for a device executing a virtual assistant application program and initiating a previously generated virtual assistant activation rule responsive to the situational information matching situational information associated with the previously generated virtual assistant activation rule.

In another embodiment, the situational information comprises the device being located within a threshold distance from another device.

In still another embodiment, the situational information comprises the device being located at a predefined location.

In yet another embodiment, the situational information comprises the device being located at a predefined location and at a predefined day or time.

In a further embodiment, the previously generated virtual assistant activation rule comprises altering an output produced by the device executing the virtual assistant application program.

In still yet another embodiment, altering comprises deactivating an output produced by the device executing the virtual assistant application program during normal operating conditions, and delaying the output produced by the device executing the virtual assistant application program or changing the output produced by the device executing the virtual assistant application program to another output format.

In another embodiment, the method further comprises outputting a virtual assistant notification, sensing an action by a user after outputting the virtual assistant notification, and creating a new virtual assistant activation rule responsive to the user action.

In still another embodiment, the user action corresponds to a predefined action.

In yet another embodiment, the predefined action comprises a recorded word or phrase.

In still yet another embodiment, the user action occurs within a threshold time from the virtual assistant notification.

In a further embodiment, the method further comprises outputting a request for the user to authorize the new virtual assistant activation rule, receiving an authorization for the new virtual assistant activation rule, and saving the new virtual assistant activation rule responsive to the authorization.

In another embodiment, the new virtual assistant activation rule comprises device situational information.

In yet another embodiment, the device situational information or the situational information comprises at least location information of the device, activity information of the device, activity information of one or more other devices located proximate to the device, or calendared information associated with the device.

In still another embodiment, the sensed activity information comprises recorded audio or video.

In a further embodiment, the recorded audio comprises at least one key word parsed from the recorded audio and initiating comprises receiving audio inputted by a user;

parsing the audio and identifying a match of at least part of the parsed audio to a previously recorded word or phrase.

In another embodiment, a computer program product comprises a computer readable storage medium having program instructions embodied therewith. The program instructions executable by a device to cause the device to receive situational information for a device executing a virtual assistant application program and initiate a previously generated virtual assistant activation rule responsive to the situational information matching situational information associated with the previously generated virtual assistant activation rule.

In yet another embodiment, the situational information comprises the device being located within a threshold distance from another device, the device being located at a predefined location, or the device being located at a predefined location and at a predefined day or time and the virtual assistant activation rule comprises altering an output produced by the device executing the virtual assistant application program.

In still another embodiment, the program instructions further cause the device to output a virtual assistant notification, sense a user action after outputting the virtual assistant notification, and create a new virtual assistant activation rule responsive to the user action.

In still yet another embodiment, the user action corresponds to a recorded word or phrase, or the user action occurs within a threshold time from the output of the virtual assistant notification.

In another embodiment, an apparatus comprises a memory a computer readable storage medium having program instructions embodied therewith, an output device configured to output notifications, an input device configured to sense or receive input, a location sensing device configured to determine location of the apparatus, a communication device configured to receive or transmit signals external to the apparatus, and a processor configured to execute the program instructions. The program instructions cause the processor to receive situational information for a device executing a virtual assistant application program, initiate a previously generated virtual assistant activation rule responsive to the situational information matching situational information associated with the previously generated virtual assistant activation rule, output a virtual assistant notification via the output device, sense a user action after outputting the virtual assistant notification via the input device, and create a new virtual assistant activation rule responsive to the user action.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving situational information for a device executing a virtual assistant application program; and
initiating a previously generated virtual assistant activation rule responsive to the situational information matching situational information associated with the previously generated virtual assistant activation rule.

2. The computer-implemented method of claim 1, wherein the situational information comprises the device being located within a threshold distance from another device.

3. The computer-implemented method of claim 1, wherein the situational information comprises the device being located at a predefined location.

4. The computer-implemented method of claim 1, wherein the situational information comprises the device being located at a predefined location and at a predefined day or time.

5. The computer-implemented method of claim 1, wherein the previously generated virtual assistant activation rule comprises altering an output produced by the device executing the virtual assistant application program.

6. The computer-implemented method of claim 5, wherein altering comprises:
deactivating an output produced by the device executing the virtual assistant application program during normal operating conditions; and
delaying the output produced by the device executing the virtual assistant application program or changing the output produced by the device executing the virtual assistant application program to another output format.

7. The computer-implemented method of claim 1, further comprising:
outputting a virtual assistant notification;
sensing an action by a user after outputting the virtual assistant notification; and
creating a new virtual assistant activation rule responsive to the action by the user.

8. The computer-implemented method of claim 7, wherein the action by the user corresponds to a predefined action.

9. The computer-implemented method of claim 8, wherein the predefined action comprises a recorded word or phrase.

10. The computer-implemented method of claim 7, wherein the action by the user occurs within a threshold time from the virtual assistant notification.

11. The computer-implemented method of claim 7, further comprising:
outputting a request for the user to authorize the new virtual assistant activation rule;
receiving an authorization for the new virtual assistant activation rule; and
saving the new virtual assistant activation rule responsive to the authorization.

12. The computer-implemented method of claim 7, wherein the new virtual assistant activation rule comprises device situational information.

13. The computer-implemented method of claim 12, wherein the device situational information or the situational information comprises at least location information of the device, activity information of the device, activity information of one or more other devices located proximate to the device, or calendared information associated with the device.

14. The computer-implemented method of claim 13, wherein the activity information comprises recorded audio or video.

15. The computer-implemented method of claim 14, wherein:
the recorded audio comprises at least one key word parsed from the recorded audio; and
initiating comprises:
receiving audio inputted by a user;
parsing the audio inputted by the user; and
identifying a match of at least part of the parsed audio to a previously recorded word or phrase.

16. A computer program product comprising a computer readable storage medium having program instructions embodied therewith, the program instructions executable by a device to cause the device to:
receive situational information for a device executing a virtual assistant application program; and
initiate a previously generated virtual assistant activation rule responsive to the situational information matching situational information associated with the previously generated virtual assistant activation rule.

17. The computer program product of claim 16, wherein:
the situational information comprises the device being located within a threshold distance from a second device, the device being located at a predefined location, or the device being located at a predefined location and at a predefined day or time; and
the virtual assistant activation rule comprises altering an output produced by the device executing the virtual assistant application program.

18. The computer program product of claim 16, wherein the program instructions further cause the device to:
output a virtual assistant notification;
sense a user action after outputting the virtual assistant notification; and
create a new virtual assistant activation rule responsive to the user action.

19. The computer program product of claim 18, wherein:
the user action corresponds to a recorded word or phrase; or
the user action occurs within a threshold time from output of the virtual assistant notification.

20. An apparatus comprising:
a memory a computer readable storage medium having program instructions embodied therewith;
an output device configured to output notifications;
an input device configured to sense or receive input;
a location sensing device configured to determine location of the apparatus;
a communication device configured to receive or transmit signals external to the apparatus; and
a processor configured to execute the program instructions, the program instructions cause the processor to:
receive situational information for a device executing a virtual assistant application program;
initiate a previously generated virtual assistant activation rule responsive to the situational information matching situational information associated with the previously generated virtual assistant activation rule;
output a virtual assistant notification via the output device;
sense a user action after outputting the virtual assistant notification via the input device; and
create a new virtual assistant activation rule responsive to the user action.
